(19) United States
(12) Patent Application Publication
(10) Pub. No.: US 2026/0016049 A1
(43) Pub. Date: Jan. 15, 2026

(54) BALL BEARING WITH AN OUTER RING-GUIDED CAGE AND AN ECCENTRIC ROTATION DEVICE

(71) Applicant: NTN CORPORATION, Osaka (JP)

(72) Inventor: Goro NAKAO, Shizuoka (JP)

(73) Assignee: NTN CORPORATION, Osaka (JP)

(21) Appl. No.: 18/881,933

(22) PCT Filed: Jul. 14, 2023
(86) PCT No.: PCT/JP2023/026059

§ 371 Date: Jan. 7, 2025

(30) Foreign Application Priority Data
Jul. 21, 2022 (JP) 2022-116513

(51) Int. Cl. F16C 33/44; F16C 19/06

(52) U.S. Cl. CPC F16C 33/44; F16C 19/06

(57) ABSTRACT

A ball bearing with an outer ring-guided cage is provided. The outer ring-guided cage is a crown-shaped resin cage including a circular annular portion disposed radially inward of one of outer ring groove shoulders so as to be opposed to the one outer ring groove shoulders; and a plurality of pillars having a cantilevered structure, and axially extending from the circular annular portion. The circular annular portion has, on its outer periphery, an outer ring guiding surface that comes into sliding contact with the one outer ring groove shoulder. Each pillar includes an outer ring guiding protrusion that comes into sliding contact with the other outer ring groove shoulder.

### TECHNICAL FIELD

The present invention relates to a ball bearing with an outer ring-guided cage, and an eccentric rotation device in which the ball bearing is used.

### BACKGROUND ART

Ball bearings are often used as bearings for supporting rotary shafts. Ball bearings include an inner ring; an outer ring arranged radially outward of, and coaxially with, the inner ring; a plurality of balls disposed between the inner ring and the outer ring; and a cage retaining the balls. The outer ring has, on its inner periphery, an outer ring raceway groove with which the balls come into rolling contact; and a pair of outer ring groove shoulders located on both axial sides of the outer ring raceway groove (e.g., the below-identified Patent Documents 1 to 5.

As a cage used in such a ball bearing, a crown-shaped resin cage is known (Patent Documents 1 to 4). The crown-shaped resin cage includes a circular annular portion disposed radially inward of one of the outer ring groove shoulders on the inner periphery of the outer ring so as to be opposed to the one outer ring groove shoulder; and a plurality of pillars having a cantilevered structure, and axially extending from the circular annular portion so as to be circumferentially spaced apart from each other. Pockets in which the respective balls are received are formed between the respective circumferentially adjacent pairs of pillars. The ball bearing in which the crown-shaped resin cage is used has the advantages of light weight, low torque, and low noise, compared to a ball bearing in which a metal cage is used.

### PRIOR ART DOCUMENT(S)

### Patent Document(s)

Patent Document 1: Japanese Unexamined Patent Application Publication No. 2002-295480
Patent Document 2: Japanese Unexamined Patent Application Publication No. 2007-056930
Patent Document 3: Japanese Unexamined Patent Application Publication No. 2007-292093
Patent Document 4: Japanese Unexamined Patent Application Publication No. 2017-116008
Patent Document 5: Japanese Unexamined Patent Application Publication No. 2007-506059

### SUMMARY OF THE INVENTION

### Problems to be Solved by the Invention

The inventor of the present application considered mounting a ball bearing to an eccentric shaft portion of an eccentric rotation device; and using a crown-shaped resin cage as a cage of the ball bearing. As a result, it turned out that if a ball-guided type of cage is used as the crown-shaped resin cage (hereinafter simply referred to as the “cage”) of the ball bearing mounted to the eccentric shaft portion, the cage comes into contact with only some of the balls with high surface pressure, so that the oil films on the surfaces of the balls could break or the cage could break, whereas if an outer ring-guided type of cage is used as the cage, due to the tilt of the cage caused by the centrifugal force due to eccentric rotation, the outer peripheries of the pillars located in the eccentric direction could come into edge abutment with the intersection ridge between the outer ring groove shoulder and the outer ring raceway groove. This is described below.

FIG. 13 illustrates an eccentric rotation device as an example. This eccentric rotation device includes a rotary shaft 30 of an electric motor; and a main shaft portion 31 and an eccentric shaft portion 32 that are integrally formed with the rotary shaft 30. The main shaft portion 31 has a cylindrical outer periphery having a center axis at the same location as the rotation center axis C0 of the rotary shaft 30. A main bearing 33 for supporting the main shaft portion 31 such that the main shaft portion 31 is rotatable at a predetermined position is mounted to the outer periphery of the main shaft portion 31. The eccentric shaft portion 32 has a cylindrical outer periphery having a center axis C1 at a position displaced by a predetermined displacement amount e from the rotation center axis C0 of the rotary shaft 30. A ball bearing 34 is mounted to the outer periphery of the eccentric shaft portion 32. An eccentric rotation member (not shown) (e.g., a rotating scroll of a scroll compressor) is mounted to the outer periphery of the ball bearing 34.

The ball bearing 34 includes an inner ring 35; an outer ring 36 arranged radially outward of, and coaxially with, the inner ring 35; a plurality of balls 37 disposed between the inner ring 35 and the outer ring 36; and a cage 38 that retains the balls 37. The outer ring 36 has, on its inner periphery, an outer ring raceway groove 39 with which the balls 37 come into rolling contact; and a pair of outer ring groove shoulders 40 and 41 located on both axial sides of the outer ring raceway groove 39. The cage 38 includes a circular annular portion 42 disposed radially inward of the outer ring groove shoulder 40 as one of the outer ring groove shoulders 40 and 41 on the inner periphery of the outer ring 36 so as to be opposed to the outer ring groove shoulder 40; and a plurality of pillars 43 having has a cantilevered structure, and axially extending from the circular annular portion 42 so as to be circumferentially spaced apart from each other.

In this eccentric rotation device, when the rotary shaft 30 of the electric motor rotates, the main shaft portion 31 rotates at a predetermined position, and the eccentric shaft portion 32 rotates eccentrically around the rotation center axis C0 of the rotary shaft 30 with a radius corresponding to the displacement amount e. At this time, the cage 38 of the ball bearing 34 rotates eccentrically around the rotation center axis C0 of the rotary shaft 30 with a radius corresponding to the displacement amount e. Therefore, unlike a cage 44 of the main bearing 33 that rotates at a predetermined position, the centrifugal force in an eccentric direction (direction toward the center axis C1 of the eccentric shaft portion 32 relative to the rotation center axis C0 or the upward direction in FIGS. 13 and 14) due to eccentric rotation acts on the cage 38. Also, the centrifugal force in the eccentric direction acts on the balls 37, too, and thus the cage 38 receives the force in the eccentric direction from the balls 37, too.

Therefore, if a ball-guided type of cage (type in which the cage 38 is radially positioned by bringing the inner surfaces of the pockets of the cage 38 into contact with the surfaces of the balls 37), which is a common type of cage, is used as the cage 38, the cage 38 comes into contact with only some of the balls 37 with high surface pressure, and a situation could occur in which the lubricant on the surfaces of the balls 37 is pushed away by the contact, the oil films on the surfaces of the balls 37 break, and peeling or seizure occurs due to insufficient lubrication. Also, if a ball-guided type of cage is used as the cage 38, the cage 38 comes into contact with only some of the balls 37 with high surface pressure, so that high stress is applied to the cage 38 and the cage 38 could break.

Therefore, the inventor of the present application considered using, as illustrated in FIGS. 13 to 15, an outer ring-guided type of cage (type in which the cage 38 is radially positioned by bringing the outer periphery of the cage 38 into contact with the inner periphery of the outer ring groove shoulder 40) as disclosed in Patent Documents 1 to 4, as the cage 38 of the ball bearing 34, which is mounted to the eccentric shaft portion 32. If an outer ring-guided type of cage is used as the cage 38, since the cage 38 is positioned not by its contact with the surfaces of the balls 37 but by its contact with the inner periphery of the outer ring groove shoulder 40, when the centrifugal force in the eccentric direction acts on the cage 38 and the balls 37, it is possible to prevent the cage 38 from coming into contact with only some of the balls 37 with high surface pressure.

However, it turned out that if an outer ring-guided type of cage is used as the cage 38 of the ball bearing 34, which is mounted to the eccentric shaft portion 32, due to the tilt of the cage 38 caused by the centrifugal force due to eccentric rotation, the outer peripheries of the pillars 43 located in the eccentric direction could come into edge abutment with the intersection ridge between the outer ring groove shoulder 40 and the outer ring raceway groove 39.

That is, it turned out that as illustrated in FIG. 16, if an outer ring-guided type of cage is used as the cage 38 such that the cage 38 is radially positioned by bringing the outer periphery of the cage 38 into contact with the inner periphery of the outer ring groove shoulder 40, when the cage 38 rotates eccentrically, the cage 38 radially moves in the eccentric direction (the upward direction in FIG. 14, the downward direction in FIG. 16) by the centrifugal force acting on the cage 38 and the balls 37 by the eccentric rotation, and the cage 38 is supported by only one of the outer ring groove shoulders 40 and 41, i.e., only the outer ring groove shoulder 40 (i.e., supported only on one side), and thus the cage 38 tilts; and that due to the tilt of the cage 38, the outer peripheries of the pillars 43 located in the eccentric direction come into edge abutment with the intersection ridge where the outer ring groove shoulder 40 and the outer ring raceway groove 39 intersect with each other, and due to this edge abutment, a situation could occur in which the cage 38 becomes worn, thereby decreasing the strength or increasing frictional torque of the bearing.

It is an object of the present invention to provide a ball bearing in which when a centrifugal force is generated by eccentric rotation, a cage is prevented from coming into contact with only some balls with high surface pressure, and due to the tilt of the cage, the outer peripheries of pillars located in an eccentric direction are prevented from coming into edge abutment with the intersection ridge between an outer ring groove shoulder and an outer ring raceway groove.

### MEANS FOR SOLVING THE PROBLEMS

In order to achieve the above object, the present invention provides the following ball bearing:

### Arrangement 1

A ball bearing with an outer ring-guided cage, the ball bearing comprising: an inner ring; an outer ring arranged radially outward of, and coaxially with, the inner ring; a plurality of balls disposed between the inner ring and the outer ring; and a crown-shaped resin cage comprising the outer ring-guided cage, and retaining the balls, wherein the outer ring has, on an inner periphery of the outer ring, an outer ring raceway groove configured such that the balls come into rolling contact with the outer ring raceway groove; and a pair of outer ring groove shoulders located on both axial sides of the outer ring raceway groove, wherein the crown-shaped resin cage includes: a circular annular portion disposed radially inward of one of the outer ring groove shoulders so as to be opposed to the one of the outer ring groove shoulders; and a plurality of pillars having a cantilevered structure, and axially extending from the circular annular portion so as to be circumferentially spaced apart from each other, and wherein the circular annular portion has, on an outer periphery of the circular annular portion, an outer ring guiding surface configured to come into sliding contact with the one of the outer ring groove shoulders, characterized in that each of the pillars includes an outer ring guiding protrusion configured to come into sliding contact with the other of the outer ring groove shoulders.

With this arrangement, since an outer ring-guided type of cage is used as the crown-shaped resin cage, when the centrifugal force due to eccentric rotation acts on the crown-shaped resin cage and the balls, it is possible to prevent the crown-shaped resin cage from coming into contact with only some of the balls with high surface pressure. Also, since the circular annular portion of the crown-shaped resin cage has, on its outer periphery, an outer ring guiding surface that comes into sliding contact with one of the outer ring groove shoulders on both axial sides of the outer ring raceway groove, and each pillar includes an outer ring guiding protrusion that comes into sliding contact with the other outer ring groove shoulder, when the crown-shaped resin cage radially moves in an eccentric direction by the centrifugal force acting on the crown-shaped resin cage and the balls due to eccentric rotation, the crown-shaped resin cage is supported by both of the outer ring groove shoulders on both axial sides of the outer ring raceway groove. Therefore, when the centrifugal force due to eccentric rotation acts on the crown-shaped resin cage and the balls, the crown-shaped resin cage is less likely to tilt, and the outer peripheries of the pillars located in the eccentric direction are prevented from coming into edge abutment with the intersection ridge between the outer ring groove shoulder and the outer ring raceway groove.

### Arrangement 2

The ball bearing according to arrangement 1, wherein each of the pillars further includes a pair of ball retaining claws axially extending to be circumferentially spaced apart from each other; and a separation groove disposed to separate the pair of ball retaining claws and the outer ring guiding protrusion from each other such that the pair of ball retaining claws are circumferentially deformable independently of the outer ring guiding protrusion.

With this arrangement, since a separation groove is formed to separate each pair of ball retaining claws and the outer ring guiding protrusion from each other, when inserting the balls into pockets each located between the circumferentially adjacent pillars, the ball retaining claws are elastically deformed smoothly. Therefore, it is possible to assemble the ball bearing easily.

### Arrangement 3

The ball bearing according to arrangement 2, wherein the pair of ball retaining claws of each of the pillars are disposed radially inward of the outer ring guiding protrusion so as to be opposed to the outer ring guiding protrusion, and wherein the separation groove of each of the pillars circumferentially extends between the pair of ball retaining claws and the outer ring guiding protrusion so as to radially separate the pair of ball retaining claws and the outer ring guiding protrusion from each other.

With this arrangement, since the pair of ball retaining claws of each pillar are disposed radially inward of the outer ring guiding protrusion so as to be opposed to the outer ring guiding protrusion, it is possible to increase the circumferential width of the outer ring guiding protrusion. Therefore, it is possible to increase the contact area between the crown-shaped resin cage and the outer ring, and effectively improve the durability of the crown-shaped resin cage.

### Arrangement 4

The ball bearing according to any one of arrangements 1 to 3, wherein the outer ring guiding protrusion of each of the pillars has, on an outer periphery of the outer ring guiding protrusion, a second outer ring guiding surface configured to come into sliding contact with the other of the outer ring groove shoulders, and wherein at both circumferential ends of the second outer ring guiding surface of each of the pillars, rounded chamfers having a circular arc-shaped cross section are disposed to be smoothly connected to the second outer ring guiding surface, or flat chamfers are disposed to intersect with the second outer ring guiding surface at an obtuse angle.

With this arrangement, since at both circumferential ends of the second outer ring guiding surface on the outer periphery of each outer ring guiding protrusion, rounded chamfers having a circular arc-shaped cross section are disposed to be smoothly connected to the second outer ring guiding surface, or flat chamfers are disposed to intersect with the second outer ring guiding surface at an obtuse angle, even when the crown-shaped resin cage moves in the eccentric direction by the centrifugal force due to eccentric rotation, and the second outer ring guiding surfaces on the outer peripheries of the outer ring guiding protrusions come into sliding contact with the outer ring groove shoulder, the lubricant on the inner periphery of the outer ring groove shoulder is less likely to be pushed away by the circumferential edges of the second outer ring guiding surfaces. Therefore, it is possible to maintain good lubrication between the second outer ring guiding surfaces on the outer peripheries of the outer ring guiding protrusions and the inner periphery of the outer ring groove shoulder.

### Arrangement 5

The ball bearing according to any one of arrangements 1 to 4, wherein pockets in which the respective balls are received are formed between respective circumferentially adjacent pairs of the pillars, and wherein each of the pockets has an inner surface comprising a radially extending cylindrical surface.

With this arrangement, when the crown-shaped resin cage moves in the eccentric direction by the centrifugal force due to eccentric rotation, it is possible to reliably prevent the inner surfaces of the pockets of the crown-shaped resin cage from interfering with the balls.

### Arrangement 6

The ball bearing according to arrangement 5, wherein a distance between distal ends of corresponding ones of the outer ring guiding protrusions located on both circumferential sides of each of the balls so as to sandwich the ball is equal to or larger than an inner diameter of the inner surface of a corresponding one of the pockets.

With this arrangement, since the distance between the distal ends of each adjacent pair of outer ring guiding protrusions is equal to or larger than the inner diameter of the inner surface of the pocket, when inserting the balls into the pockets, it is possible to reliably prevent the balls from interfering with the outer ring guiding protrusions.

### Arrangement 7

The ball bearing according to any one of arrangements 1 to 4, wherein pockets in which the respective balls are received are formed between respective circumferentially adjacent pairs of the pillars, wherein each of the pockets has an inner surface comprising a spherical surface along a surface of a corresponding one of the balls, wherein an opening of each of the pockets leading to an outer periphery of the crown-shaped resin cage has a circular arc edge that has a semicircular shape and that is axially open, and wherein a distance between distal ends of corresponding ones of the outer ring guiding protrusions located on both circumferential sides of each of the balls so as to sandwich the ball is equal to or larger than a circular arc diameter of the circular arc edge of a corresponding one of the pockets.

With this arrangement, since the distance between the distal ends of each adjacent pair of outer ring guiding protrusions is equal to or larger than the circular arc diameter of the circular arc edge of the opening of the pocket leading to the outer periphery of the crown-shaped resin cage, when inserting the balls into the pockets, it is possible to reliably prevent the balls from interfering with the outer ring guiding protrusions.

### Arrangement 8

The ball bearing according to arrangements 2 or 3, wherein a distance between distal ends of corresponding ones of the ball retaining claws of the pillars circumferentially opposed to each other so as to sandwich each of the balls is set to 80% or more and 92% or less of a diameter of the ball.

The present invention also provides the following as an eccentric rotation device in which the ball bearing according to the above arrangements is used:

An eccentric rotation device comprising: a rotary shaft configured to rotate at a predetermined position; an eccentric shaft portion having a cylindrical outer periphery having a center axis at a position displaced from a rotation center axis of the rotary shaft, the eccentric shaft portion being configured to rotate eccentrically around the rotation center axis of the rotary shaft; and the ball bearing according to any one of arrangements 1 to 8 mounted to an outer periphery of the eccentric shaft portion.

### EFFECTS OF THE INVENTION

In the ball bearing of the present invention, since an outer ring-guided type of cage is used as the crown-shaped resin cage, when the centrifugal force due to eccentric rotation acts on the crown-shaped resin cage and the balls, it is possible to prevent the crown-shaped resin cage from coming into contact with only some of the balls with high surface pressure. Also, since the circular annular portion of the crown-shaped resin cage has, on its outer periphery, an outer ring guiding surface that comes into sliding contact with one of the outer ring groove shoulders on both axial sides of the outer ring raceway groove, and each pillar includes an outer ring guiding protrusion that comes into sliding contact with the other outer ring groove shoulder, when the crown-shaped resin cage radially moves in an eccentric direction by the centrifugal force acting on the crown-shaped resin cage and the balls due to eccentric rotation, the crown-shaped resin cage is supported by both of the outer ring groove shoulders on both axial sides of the outer ring raceway groove. Therefore, when the centrifugal force due to eccentric rotation acts on the crown-shaped resin cage and the balls, the crown-shaped resin cage is less likely to tilt, and the outer peripheries of the pillars located in the eccentric direction are prevented from coming into edge abutment with the intersection ridge between the outer ring groove shoulder and the outer ring raceway groove.

### BRIEF DESCRIPTION OF THE DRAWINGS

FIG. 1 is a sectional view of a ball bearing with an outer ring-guided cage according to a first embodiment of the present invention.

FIG. 2 is a partial sectional view of the ball bearing of FIG. 1 when seen from the other axial side (right side in FIG. 1)

FIG. 3 is an enlarged view illustrating a portion of a crown-shaped resin cage of FIG. 2, balls and their vicinities.

FIG. 4 is a sectional view illustrating a state in which when the ball bearing of FIG. 1 is rotated eccentrically, the crown-shaped resin cage is radially moved in an eccentric direction (downward direction in FIG. 4) by the centrifugal force due to the eccentric rotation, and the outer periphery of the crown-shaped resin cage is in sliding contact with a pair of outer ring groove shoulders.

FIG. 5 is a sectional view taken along line V-V of FIG. 4.

FIG. 6 is a view illustrating the crown-shaped resin cage of FIG. 2.

FIG. 7 is a sectional view taken along line VII-VII of FIG. 6.

FIG. 8 is a view illustrating the crown-shaped resin cage of FIG. 6 when seen from the radially outer side.

FIG. 9 is a perspective view of the crown-shaped resin cage of FIG. 6.

FIG. 10 is a view illustrating a second embodiment of the present invention, and corresponding to FIG. 2.

FIG. 11 is an enlarged view illustrating a portion of a crown-shaped resin cage of FIG. 10, balls and their vicinities.

FIG. 12 is a perspective view of the crown-shaped resin cage of FIG. 10.

FIG. 13 is a sectional view of an eccentric rotation device.

FIG. 14 is a sectional view taken along line XIV-XIV of FIG. 13.

FIG. 15 is an enlarged view of a ball in an eccentric direction in FIG. 14 (upward direction in the drawing) and its vicinity.

FIG. 16 is a sectional view illustrating a state in which a crown-shaped resin cage of a comparative example illustrated in FIG. 13 is radially moved in an eccentric direction (downward direction in FIG. 16) by the centrifugal force due to eccentric rotation, and the outer periphery of the crown-shaped resin cage is in sliding contact with an outer ring groove shoulder on one axial side, the sectional view corresponding to FIG. 4.

### BEST MODE FOR CARRYING OUT THE INVENTION

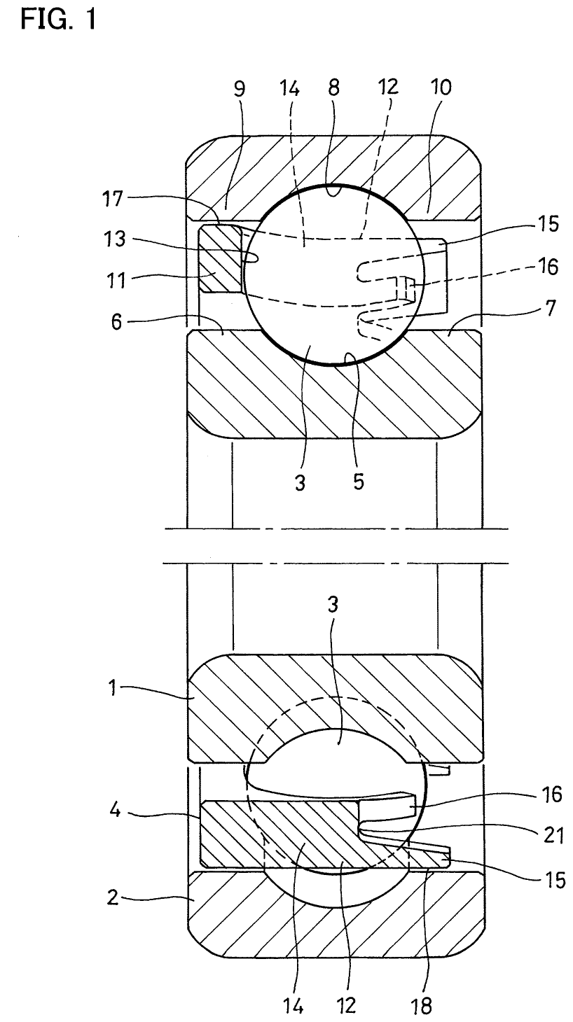

FIG. 1 illustrates a ball bearing with an outer ring-guided cage according to a first embodiment of the present invention. This ball bearing includes an inner ring 1; an outer ring 2 arranged radially outward of, and coaxially with, the inner ring 1; a plurality of balls 3 disposed between the inner ring 1 and the outer ring 2 so as to be circumferentially spaced apart from each other; and a crown-shaped resin cage 4 (hereinafter simply referred to as the “cage 4”) that retains the balls 3. This ball bearing is used in an environment lubricated with lubricating oil or grease.

The inner ring 1 has, on its outer periphery, an inner ring raceway groove 5 with which the balls 3 come into rolling contact; and a pair of inner ring groove shoulders 6 and 7 located axially outward of the inner ring raceway groove 5. The inner ring raceway groove 5 extends circumferentially at the axial central portion of the outer periphery of the inner ring 1. The inner ring groove shoulders 6 and 7 extend circumferentially on both axial sides of the inner ring raceway groove 5.

The outer ring 2 has, on its inner periphery, an outer ring raceway groove 8 with which the balls 3 come into rolling contact; and a pair of outer ring groove shoulders 9 and 10 located axially outward of the outer ring raceway groove 8. The outer ring raceway groove 8 extends circumferentially at the axial central portion of the inner periphery of the outer ring 2. The outer ring groove shoulders 9 and 10 extend circumferentially on both axial sides of the outer ring raceway groove 8. The inner peripheries of the outer ring groove shoulders 9 and 10 are cylindrical surfaces each having a constant inner diameter that does not change in the axial direction. The inner diameters of the outer ring groove shoulders 9 and 10 are equal to each other.

The balls 3 are radially sandwiched between the inner ring raceway groove 5 and the outer ring raceway groove 8. This ball bearing is a deep groove ball bearing. That is, the inner ring raceway groove 5 is a circular arc-shaped groove having a concave circular arc-shaped cross section symmetrical in the axial direction, and the outer ring raceway groove 8 is also a circular arc-shaped groove having a concave circular arc-shaped cross section symmetrical in the axial direction.

The cage 4 includes a circular annular portion 11 disposed radially inward of the outer ring groove shoulder 9 so as to be opposed to the outer ring groove shoulder 9; and pillars 12 each axially extending from the circular annular portion 11 so as to be located between the circumferentially adjacent balls 3. Each pillar 12 has a cantilevered structure having one axial end as a fixed end fixed to the circular annular portion 11 and the other axial end as a free end. The pillars 12 are circumferentially spaced apart from each other. Pockets 13 in which the respective balls 3 are received are each formed between the circumferentially adjacent pillars 12.

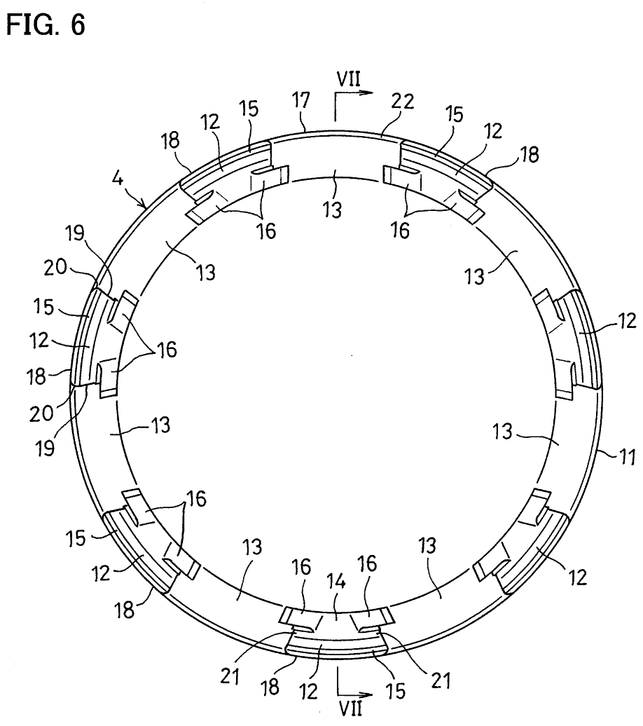

As illustrated in FIGS. 6, 7 and 9, each pillar 12 is a trifurcated pillar including a pillar base 14 extending axially from the circular annular portion 11; and an outer ring guiding protrusion 15 and a pair of ball retaining claws 16 that are three portions branching off from the distal end of the pillar base 14, and extending in the axial direction. As illustrated in FIG. 1, the outer ring guiding protrusions 15 of the pillars 12 are axial protrusions that come into sliding contact with the inner periphery of the outer ring groove shoulder 10. The ball retaining claws 16 of the pillars 12 retain the balls 3 so as not to axially move out of the pockets 13.

The circular annular portion 11 and the pillars 12 are formed as a seamless integral member made of a resin composition in which a fiber-reinforced material is added to a resin material. As the resin material of the resin composition as its base, it is possible to use polyamide (PA) or super engineering plastic. As the polyamide, it is possible to use polyamide 46 (PA46), polyamide 66 (PA66), polynonamethylene terephthalamide (PA9T), or the like. As the super engineering plastic, it is possible to use polyether ether ketone (PEEK) or polyphenylene sulfide (PPS). As the fiber-reinforced material added to the resin material, it is possible to use glass fiber, carbon fiber, aramid fiber, or the like. The fiber-reinforced material is added to account for 10 to 50% by weight of the resin composition forming the cage 4.

As illustrated in FIG. 1, the circular annular portion 11 circumferentially extends on one axial side of the balls 3. The circular annular portion 11 has, on its outer periphery, an outer ring guiding surface 17 that comes into sliding contact with the outer ring groove shoulder 9. The outer ring guiding surface 17 is a cylindrical surface having a constant outer diameter that does not change in the axial direction. The outer ring guiding surface 17 is opposed to the radially inner side of the outer ring groove shoulder 9 via a minute gap (e.g., a gap having a radius of 0.5 mm or less).

The inner surface of each pocket 13, in which the ball 3 is received, is constituted by the surfaces of the pillar bases 14 opposed to the ball 3, and the surfaces of the ball retaining claws 16 opposed to the ball 3. In FIG. 1, the inner surface of each pocket 13 is a radially extending cylindrical surface. The axial length of each pillar base 14 (the axial distance from the bottom of the pocket 13 to the boundary between the pillar base 14 and the ball retaining claws 16) is larger than the radius of the ball 3.

The outer ring guiding protrusion 15 of each pillar 12 has a second outer ring guiding surface 18 disposed at the outer periphery of the axial end portion of the guiding protrusion 15 remote from the circular annular portion 11, and configured to come into sliding contact with the outer ring groove shoulder 10. The second outer ring guiding surface 18 is a cylindrical surface having a constant outer diameter that does not change in the axial direction. The second outer ring guiding surface 18 is opposed to the radially inner side of the outer ring groove shoulder 10 via a minute gap (e.g., a gap having a radius of 0.5 mm or less). The outer diameter of the second outer ring guiding surface 18 is equal to the outer diameter of the outer ring guiding surface 17 on the outer periphery of the circular annular portion 11. As illustrated in FIGS. 3 and 8, the side surfaces 19 of the outer ring guiding protrusion 15 on both axial sides thereof are flat surfaces each connected to the cylindrical inner surface of the pocket 13.

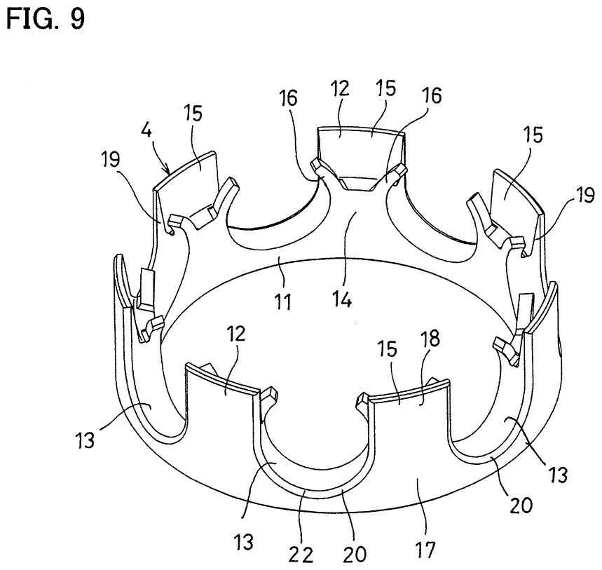

As illustrated in FIGS. 6 and 8, rounded chamfers 20 having a circular arc-shaped cross section are disposed at both circumferential ends of each second outer ring guiding surface 18 (intersection ridges between the second outer ring guiding surface 18 and the respective side surfaces 19 of the outer ring guiding protrusion 15 on both axial sides thereof) so as to be smoothly connected to the second outer ring guiding surface 18. Instead of the rounded chamfers 20, flat chamfers that intersect with the second outer ring guiding surface 18 at an obtuse angle may be disposed. As illustrated in FIGS. 8 and 9, in the shown example, a rounded chamfer 20 is formed at the entire opening edge of each pocket 13 leading to the outer periphery of the cage 4.

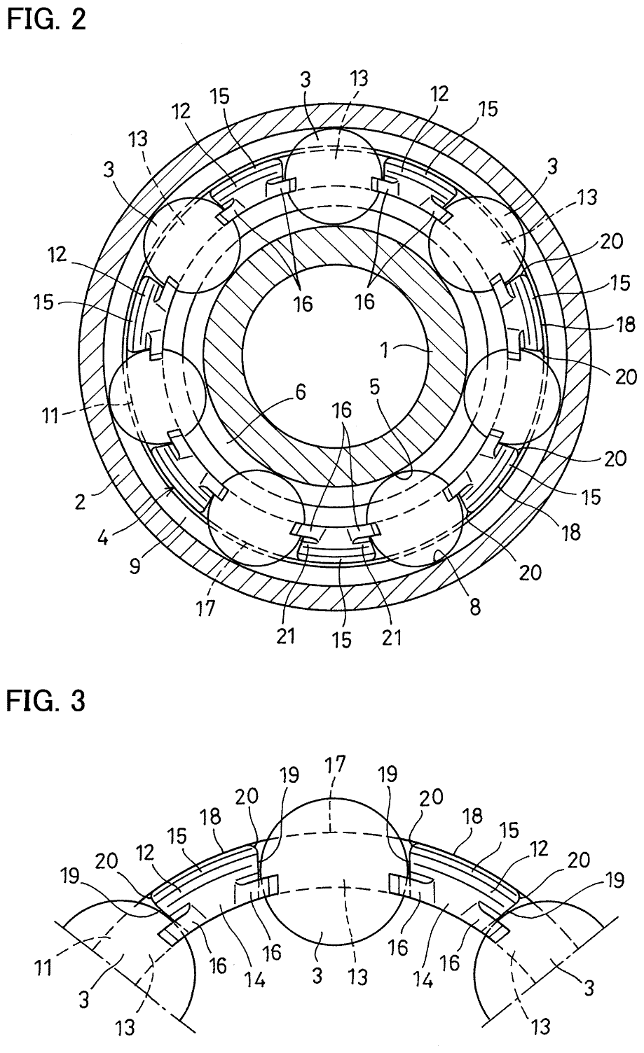

As illustrated in FIGS. 2 and 3, each pillar 12 has a pair of ball retaining claws 16 circumferentially spaced apart from each other. As illustrated in FIG. 3, of the two pillars 12 located on both circumferential sides of each ball 3 so as to sandwich the ball 3, the ball retaining claw 16 on the other circumferential side (right side in FIG. 3) of the pillar 12 located on one circumferential side (left side in FIG. 3) of the ball 3, and the ball retaining claw 16 on one circumferential side (left side in FIG. 3) of the pillar 12 located on the other circumferential side (right side in FIG. 3) of the ball 3 are circumferentially opposed to each other with the ball 3 sandwiched therebetween, and hold the ball 3 from both circumferential sides.

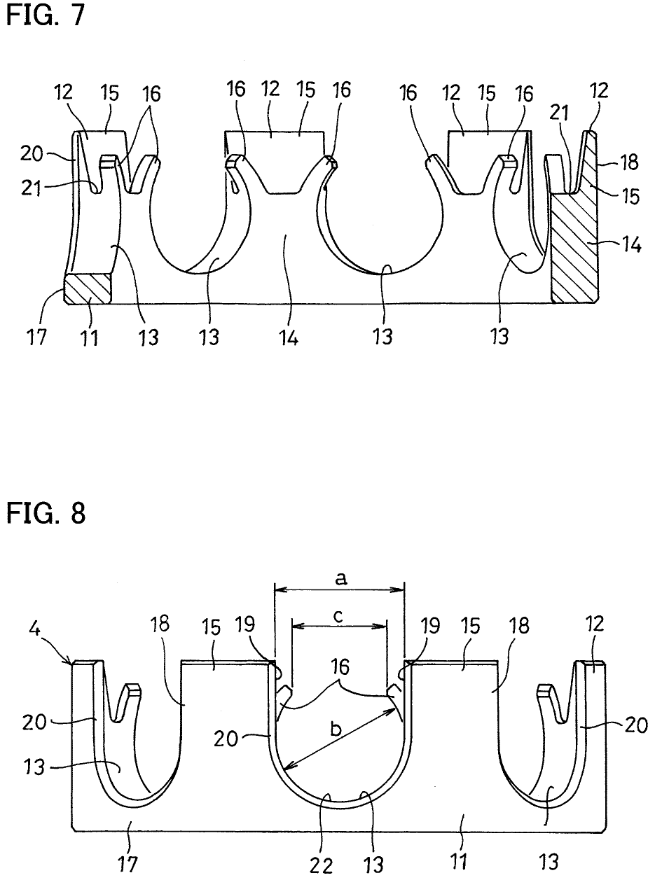

As illustrated in FIGS. 6 and 7, the pair of ball retaining claws 16 of each pillar 12 are disposed radially inward of the outer ring guiding protrusion 15 so as to be opposed to the outer ring guiding protrusion 15. A separation groove 21 is formed between each pair of ball retaining claws 16 and the outer ring guiding protrusion 15 so as to separate the pair of ball retaining claws 16 and the outer ring guiding protrusion 15 from each other. By forming the separation groove 21, the pair of ball retaining claws 16 and the outer ring guiding protrusion 15 are separated from each other such that the pair of ball retaining claws 16 are circumferentially elastically deformable independently of the outer ring guiding protrusion 15. In the relevant drawings, the separation groove 21 is a circumferential groove circumferentially extending between the pair of ball retaining claws 16 and the outer ring guiding protrusion 15 so as to radially separate the pair of ball retaining claws 16 and the outer ring guiding protrusion 15 from each other.

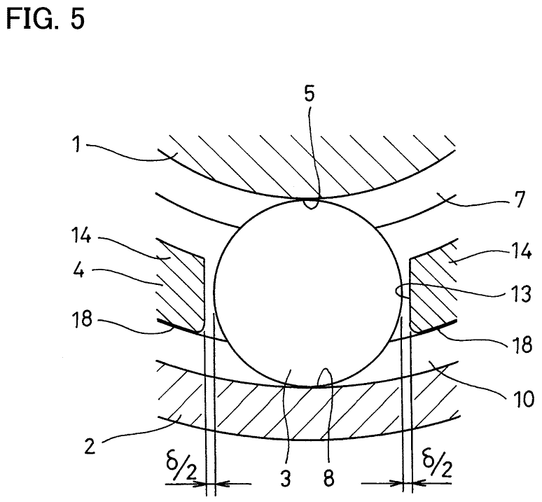

As illustrated in FIG. 8, the opening of each pocket 13 leading to the outer periphery of the cage 4 has a circular arc edge 22 that has a semicircular shape and that is open in the axial direction. The distance a between the distal ends of the outer ring guiding protrusions 15 located on both circumferential sides of each ball 3 (see FIG. 3) so as to sandwich the ball 3 is equal to or larger than the circular arc diameter b of the circular arc edge 22 (in this embodiment, the circular arc diameter b of the circular arc edge 22 is equal to the inner diameter of the cylindrical inner surface of the pocket 13). The distance c between the distal ends of the ball retaining claws 16 circumferentially opposed to each other so as to sandwich each ball 3 is set to 80% or more and 92% or less of the diameter of the ball 3 (see FIG. 3). As illustrated in FIG. 5, the size of the circumferential gap 8 between each ball 3 and the inner surface of the pocket 13 is set to 0.2 mm or more and 0.5 mm or less.

This ball bearing can be assembled as follows: First, the inner ring 1, the outer ring 2 and the balls 3 illustrated in FIG. 1 are prepared, and the balls 3 are placed between the inner ring 1 and outer ring 2. Next, the circumferential positions of the balls 3 are adjusted so that the balls 3 are circumferentially equidistantly spaced apart from each other. Then, the cage 4 is axially pushed in between the inner ring 1 and the outer ring 2. At this time, the ball retaining claws 16 are pressed by the balls 3, and are circumferentially elastically deformed temporarily, and each ball 3 is inserted into the pocket 13 by passing through the space between the distal ends of the ball retaining claws 16 widened by the elastic deformation.

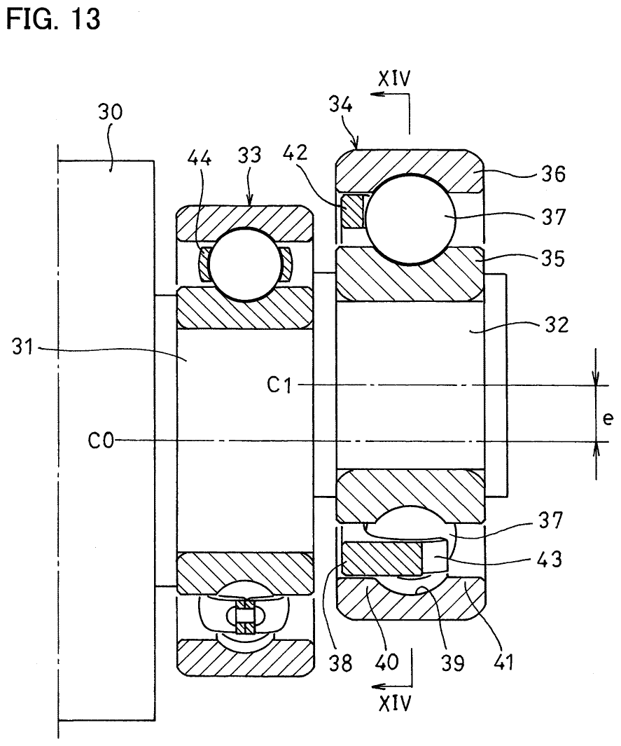

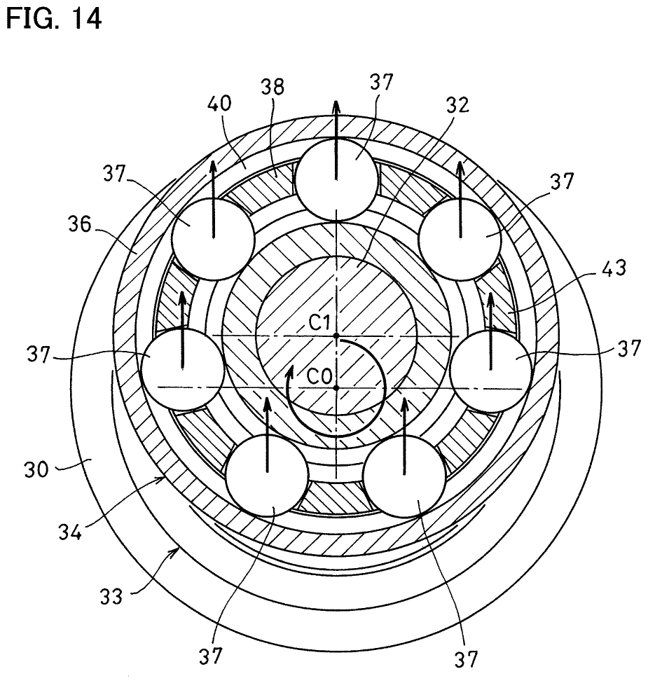

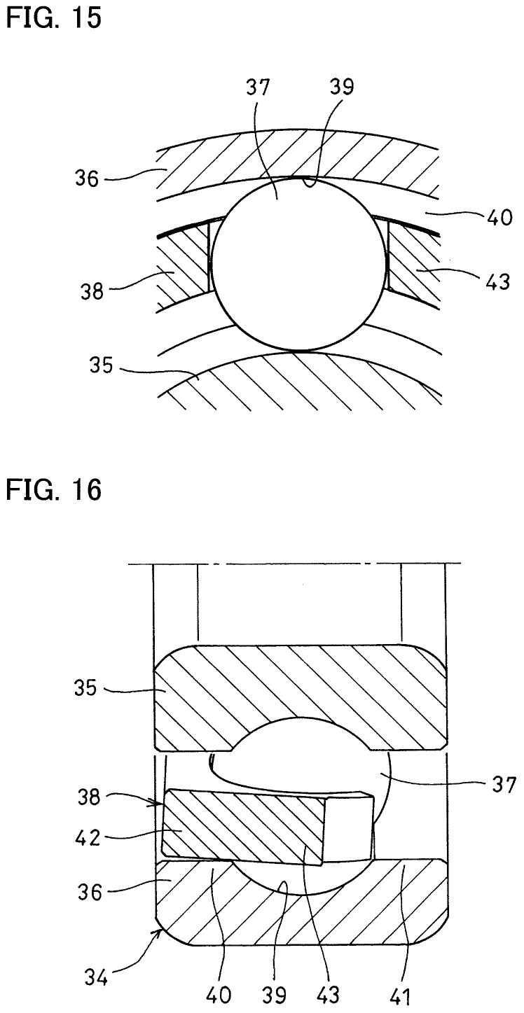

This ball bearing is mounted to the outer periphery of an eccentric shaft portion 32 of an eccentric rotation device as illustrated in FIGS. 13 and 14. That is, the ball bearing of the above embodiment can be used as a ball bearing 34 illustrated in FIGS. 13 and 14. The eccentric rotation device illustrated in FIGS. 13 and 14 includes a rotary shaft 30 of an electric motor that rotates at a predetermined position; a main shaft portion 31 having a cylindrical outer periphery having a center axis at the same location as the rotation center axis C0 of the rotary shaft 30; an eccentric shaft portion 32 having a cylindrical outer periphery having a center axis C1 at a position displaced from the rotation center axis C0 of the rotary shaft 30; a main bearing 33 mounted to the outer periphery of the main shaft portion 31; and a ball bearing 34 mounted to the outer periphery of the eccentric shaft portion 32. The eccentric rotation device is configured such that by the rotary driving force of the rotary shaft 30, the eccentric shaft portion 32 rotates eccentrically around the rotation center axis C0 of the rotary shaft 30 with a radius corresponding to a displacement amount e.

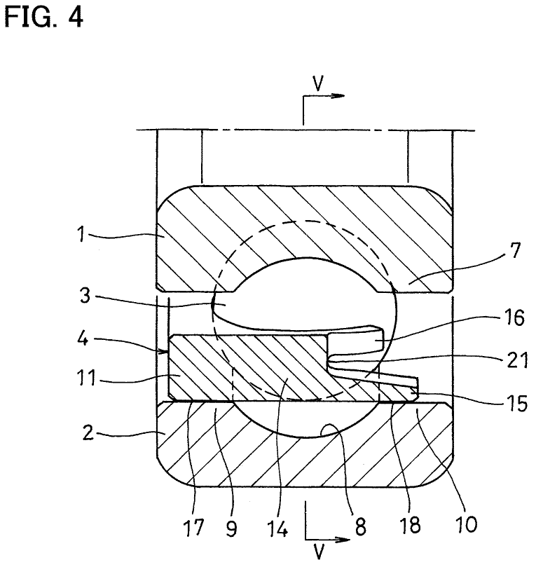

In the ball bearing of this embodiment, as illustrated in FIG. 1, an outer ring-guided type of cage (type in which the cage 4 is radially positioned by bringing the outer periphery of the cage 4 into contact with the inner periphery of the outer ring 2) is used as the cage 4. Therefore, when the ball bearing is mounted to the outer periphery of the eccentric shaft portion 32 of the eccentric rotation device illustrated in FIGS. 13 and 14, as illustrated in FIG. 4, the centrifugal force due to eccentric rotation can be supported by the contact portions of the outer periphery of the cage 4 and the inner periphery of the outer ring 2. Therefore, it is possible to prevent the cage 4 from coming into contact with only some of the balls 3 with high surface pressure when a centrifugal force is generated by eccentric rotation, unlike a case where a ball-guided type of cage (type in which the cage 4 is radially positioned by bringing the inner surfaces of the pockets 13 of the cage 4 into contact with the surfaces of the balls 3) is used.

Also, in this ball bearing, since, as illustrated in FIG. 1, the circular annular portion 11 of the cage 4 has, on its outer periphery, an outer ring guiding surface 17 that comes into sliding contact with the outer ring groove shoulder 9 as one of the outer ring groove shoulders 9 and 10 on both axial sides of the outer ring raceway groove 8, and each pillar 12 includes an outer ring guiding protrusion 15 that comes into sliding contact with the other outer ring groove shoulder 10, when, as illustrated in FIG. 4, the cage 4 radially moves in an eccentric direction (direction toward the center axis C1 of the eccentric shaft portion 32 relative to the rotation center axis C0 in FIG. 13 or the downward direction in FIG. 4) by the centrifugal force acting on the cage 3 and the balls 4 due to eccentric rotation, the cage 4 is supported by both of the outer ring groove shoulders 9 and 10 on both axial sides of the outer ring raceway groove 8. Therefore, when the centrifugal force due to eccentric rotation acts on the cage 4 and the balls 3, the cage 4 is less likely to tilt, and the outer peripheries of the pillars 12 located in the eccentric direction are prevented from coming into edge abutment with the intersection ridge between the outer ring groove shoulder 9 and the outer ring raceway groove 8.

Also, in this ball bearing, since, as illustrated in FIG. 7, a separation groove 21 is formed to separate each pair of ball retaining claws 16 and the outer ring guiding protrusion 15 from each other, when inserting the balls 3 into the pockets 13, which are each located between the circumferentially adjacent pillars 12, the ball retaining claws 16 are elastically deformed smoothly. Therefore, it is possible to assemble the ball bearing easily.

Also, in this ball bearing, since, as illustrated in FIG. 6, the pair of ball retaining claws 16 of each pillar 12 are disposed radially inward of the outer ring guiding protrusion 15 so as to be opposed to the outer ring guiding protrusion 15, it is possible to increase the circumferential width of the outer ring guiding protrusion 15. Therefore, it is possible to increase the contact area between the cage 4 and the outer ring 2, and effectively improve the durability of the cage 4.

Also, in this ball bearing, since, as illustrated in FIGS. 8 and 9, rounded chamfers 20 having a circular arc-shaped cross section are disposed at both circumferential ends of the second outer ring guiding surface 18 on the outer periphery of each outer ring guiding protrusion 15 so as to be smoothly connected to the second outer ring guiding surface 18, as illustrated in FIGS. 4 and 5, even when the cage 4 moves in the eccentric direction by the centrifugal force due to eccentric rotation, and the second outer ring guiding surfaces 18 on the outer peripheries of the outer ring guiding protrusions 15 come into sliding contact with the outer ring groove shoulder 10, the lubricant on the inner periphery of the outer ring groove shoulder 10 is less likely to be pushed away by the circumferential edges of the second outer ring guiding surfaces 18. Therefore, it is possible to maintain good lubrication between the second outer ring guiding surfaces 18 on the outer peripheries of the outer ring guiding protrusions 15 and the inner periphery of the outer ring groove shoulder 10. Even in a case where at both circumferential ends of the second outer ring guiding surface 18 on the outer periphery of each outer ring guiding protrusion 15, flat chamfers that intersect with the second outer ring guiding surface 18 at an obtuse angle are disposed instead of the rounded chamfers 20, it is possible to obtain the same action effect.

Also, in this ball bearing, since, as illustrated in FIG. 5, the inner surface of each pocket 13 is a radially extending cylindrical surface, when the cage 4 moves in the eccentric direction by the centrifugal force due to eccentric rotation, it is possible to reliably prevent the inner surfaces of the pockets 13 of the cage 4 from interfering with the balls 3.

Also, in this ball bearing, since, as illustrated in FIG. 8, the distance a between the distal ends of each adjacent pair of outer ring guiding protrusions 15 is equal to or larger than the inner diameter b of the inner surface of the pocket 13, when inserting the balls 3 into the pockets 13, it is possible to reliably prevent the balls 3 from interfering with the outer ring guiding protrusions 15. Also, when forming the cage 4 with a resin, it is possible to avoid a situation where the cage 4 is forcibly removed from the mold.

Also, since the cage 4 is formed of a resin composition, this ball bearing has self-lubricating properties even when used under dilute lubrication conditions. Also, since the cage 4 is formed of a resin composition, this ball bearing is quiet and low-noise even when used under eccentric rotation.

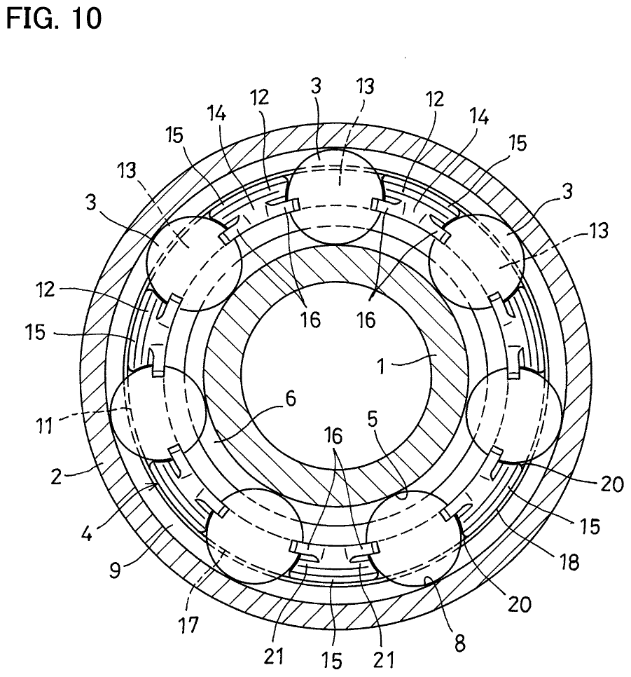

FIGS. 10 to 12 illustrate a second embodiment of the present invention. The second embodiment is different from the first embodiment only in that the pockets 13 of the cage 4 have a different shape, and the second embodiment is basically the same as the first embodiment in the other structures. Therefore, the elements of the second embodiment corresponding to those of the first embodiment are denoted by the same numerals, and the description thereof is omitted.

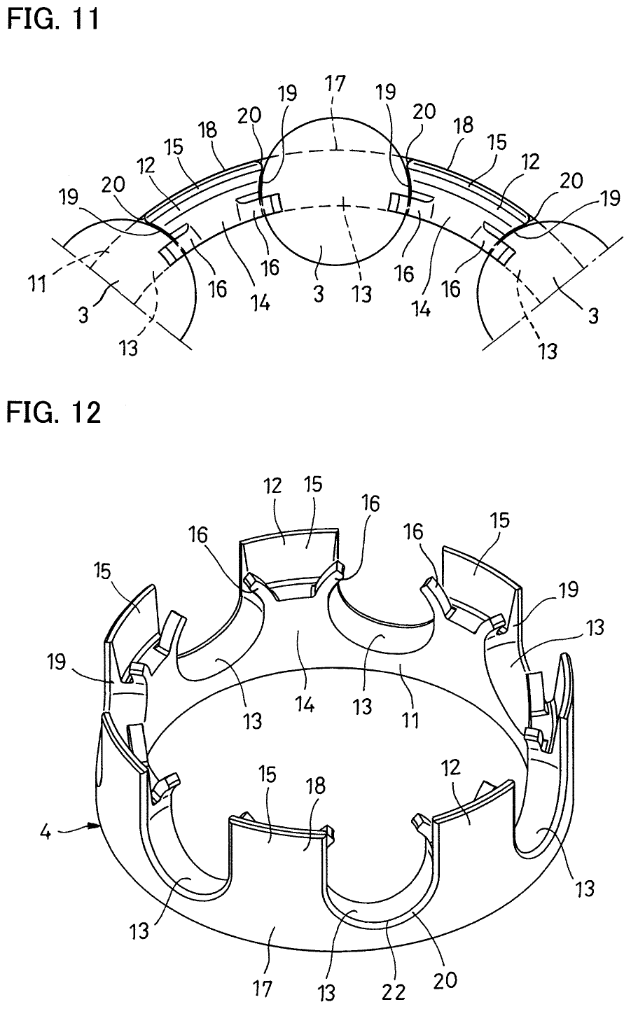

The surfaces of the pillar bases 14 opposed to each ball 3 and the surfaces of the ball retaining claws 16 opposed to the ball 3 define the inner surface of the pocket 13, in which the ball 3 is received. The inner surface of each pocket 13 is a spherical surface along the surface of the ball 3. As illustrated in FIG. 11, the side surfaces 19 of each outer ring guiding protrusion 15 on both axial sides thereof are cylindrical surfaces connected to the spherical inner surfaces of the pockets 13 (cylindrical surfaces extending parallel to the axial direction). As in the first embodiment, the ball bearing of this embodiment can also be mounted to the outer periphery of the eccentric shaft portion 32 of the eccentric rotation device illustrated in FIGS. 13 and 14.

In the ball bearing of this embodiment, too, as in the first embodiment, an outer ring-guided type of cage is used as the cage 4. Therefore, it is possible to prevent the cage 4 from coming into contact with only some of the balls 3 with high surface pressure when the centrifugal force due to eccentric rotation acts on the cage 4 and balls 3. Also, since the circular annular portion 11 of the cage 4 has, on its outer periphery, an outer ring guiding surface 17 that comes into sliding contact with the outer ring groove shoulder 9 as one of the outer ring groove shoulders 9 and 10, and each pillar 12 includes an outer ring guiding protrusion 15 that comes into sliding contact with the other outer ring groove shoulder 10 (see FIG. 4), when the cage 4 radially moves in the eccentric direction by the centrifugal force acting on the crown-shaped resin cage 4 and the balls 3 by eccentric rotation, the cage 4 is supported by both of the outer ring groove shoulders 9 and 10 on both axial sides of the outer ring raceway groove 8. Therefore, when the centrifugal force due to eccentric rotation acts on the cage 4 and balls 3, the cage 4 is less likely to tilt, and the outer peripheries of the pillars 12 located in the eccentric direction are prevented from coming into edge abutment with the intersection ridge between the outer ring groove shoulder 9 and the outer ring raceway groove 8. The other actions and effects are also the same as those of the first embodiment.

While, in each of the above embodiments, a hollow annular member having an inner ring raceway groove 5 in the outer periphery is exemplified and described as the inner ring 1, the inner ring 1 does not necessarily need to be a hollow annular member. For example, a solid member (shaft body) having an inner ring raceway groove 5 which is directly formed in the outer periphery and with which the balls 3 come into rolling contact may be used as the inner ring 1. In short, an inner member having, in the outer periphery, an annular inner ring raceway groove 5 with which the balls 3 come into rolling contact can be used as the inner ring.

While, in each of the above embodiments, a hollow annular member having an outer ring raceway groove 8 in the inner periphery is exemplified and described as the outer ring 2, the outer ring 2 does not necessarily need to be a hollow annular member. For example, a bearing housing having an outer ring raceway groove 8 which is directly formed in the inner periphery and with which the balls 3 come into rolling contact may be used as the outer ring 2. In short, an outer member having, in the inner periphery, an annular outer ring raceway groove 8 with which the balls 3 come into rolling contact can be used as the outer ring.

The above-described embodiments are mere examples in every respect, and the present invention is not limited thereto. The scope of the present invention is indicated not by the above description but by the claims, and should be understood to include all modifications within the meaning and scope equivalent to the scope of the claims.

### DESCRIPTION OF REFERENCE NUMERALS

1: Inner ring
2: Outer ring
3: Ball
4: Crown-shaped resin cage
8: Outer ring raceway groove
9, 10: Outer ring groove shoulder
11: Circular annular portion
12: Pillar
13: Pocket
15: Outer ring guiding protrusion
16: Ball retaining claw
17: Outer ring guiding surface
18: Second outer ring guiding surface
20: Rounded chamfer
21: Separation groove
22: Circular arc edge
30: Rotary shaft
32: Eccentric shaft portion
a: Distance between the distal ends of outer ring guiding protrusions
b: Inner diameter of the inner surface of the pocket (circular arc diameter of the circular arc edge)
c: Distance between the distal ends of ball retaining claws
C0: Rotation center axis of the rotary shaft
C1: Center axis of the outer periphery of the eccentric shaft portion

1. A ball bearing with an outer ring-guided cage, the ball bearing comprising:
an inner ring;
an outer ring arranged radially outward of, and coaxially with, the inner ring;
a plurality of balls disposed between the inner ring and the outer ring; and
a crown-shaped resin cage comprising the outer ring-guided cage, and retaining the balls,
wherein the outer ring has, on an inner periphery of the outer ring,
an outer ring raceway groove configured such that the balls come into rolling contact with the outer ring raceway groove; and
a pair of outer ring groove shoulders located on both axial sides of the outer ring raceway groove,
wherein the crown-shaped resin cage includes:
a circular annular portion disposed radially inward of one of the outer ring groove shoulders so as to be opposed to the one of the outer ring groove shoulders; and
a plurality of pillars having a cantilevered structure, and axially extending from the circular annular portion so as to be circumferentially spaced apart from each other, and
wherein the circular annular portion has, on an outer periphery of the circular annular portion, an outer ring guiding surface configured to come into sliding contact with the one of the outer ring groove shoulders, and
wherein each of the pillars includes an outer ring guiding protrusion configured to come into sliding contact with the other of the outer ring groove shoulders.

2. The ball bearing according to claim 1, wherein each of the pillars further includes a pair of ball retaining claws axially extending to be circumferentially spaced apart from each other; and
a separation groove disposed to separate the pair of ball retaining claws and the outer ring guiding protrusion from each other such that the pair of ball retaining claws are circumferentially deformable independently of the outer ring guiding protrusion.

3. The ball bearing according to claim 2, wherein the pair of ball retaining claws of each of the pillars are disposed radially inward of the outer ring guiding protrusion so as to be opposed to the outer ring guiding protrusion, and
wherein the separation groove of each of the pillars circumferentially extends between the pair of ball retaining claws and the outer ring guiding protrusion so as to radially separate the pair of ball retaining claws and the outer ring guiding protrusion from each other.

4. The ball bearing according to claim 1, wherein the outer ring guiding protrusion of each of the pillars has, on an outer periphery of the outer ring guiding protrusion, a second outer ring guiding surface configured to come into sliding contact with the other of the outer ring groove shoulders, and
wherein at both circumferential ends of the second outer ring guiding surface of each of the pillars, rounded chamfers having a circular arc-shaped cross section are disposed to be smoothly connected to the second outer ring guiding surface, or flat chamfers are disposed to intersect with the second outer ring guiding surface at an obtuse angle.

5. The ball bearing according to claim 1, wherein pockets in which the respective balls are received are formed between respective circumferentially adjacent pairs of the pillars, and
wherein each of the pockets has an inner surface comprising a radially extending cylindrical surface.

6. The ball bearing according to claim 5, wherein a distance between distal ends of corresponding ones of the outer ring guiding protrusions located on both circumferential sides of each of the balls so as to sandwich the ball is equal to or larger than an inner diameter of the inner surface of a corresponding one of the pockets.

7. The ball bearing according to claim 1, wherein pockets in which the respective balls are received are formed between respective circumferentially adjacent pairs of the pillars,
wherein each of the pockets has an inner surface comprising a spherical surface along a surface of a corresponding one of the balls,
wherein an opening of each of the pockets leading to an outer periphery of the crown-shaped resin cage has a circular arc edge that has a semicircular shape and that is axially open, and
wherein a distance between distal ends of corresponding ones of the outer ring guiding protrusions located on both circumferential sides of each of the balls so as to sandwich the ball is equal to or larger than a circular arc diameter of the circular arc edge of a corresponding one of the pockets.

8. The ball bearing according to claim 2, wherein a distance between distal ends of corresponding ones of the ball retaining claws of the pillars circumferentially opposed to each other so as to sandwich each of the balls is set to 80% or more and 92% or less of a diameter of the ball.

9. An eccentric rotation device comprising:
a rotary shaft configured to rotate at a predetermined position;
an eccentric shaft portion having a cylindrical outer periphery having a center axis at a position displaced from a rotation center axis of the rotary shaft, the eccentric shaft portion being configured to rotate eccentrically around the rotation center axis of the rotary shaft; and
the ball bearing according to claim 1 mounted to an outer periphery of the eccentric shaft portion.

10. The ball bearing according to claim 2, wherein the outer ring guiding protrusion of each of the pillars has, on an outer periphery of the outer ring guiding protrusion, a second outer ring guiding surface configured to come into sliding contact with the other of the outer ring groove shoulders, and
wherein at both circumferential ends of the second outer ring guiding surface of each of the pillars, rounded chamfers having a circular arc-shaped cross section are disposed to be smoothly connected to the second outer ring guiding surface, or flat chamfers are disposed to intersect with the second outer ring guiding surface at an obtuse angle.

11. The ball bearing according to claim 3, wherein the outer ring guiding protrusion of each of the pillars has, on an outer periphery of the outer ring guiding protrusion, a second outer ring guiding surface configured to come into sliding contact with the other of the outer ring groove shoulders, and
wherein at both circumferential ends of the second outer ring guiding surface of each of the pillars, rounded chamfers having a circular arc-shaped cross section are disposed to be smoothly connected to the second outer ring guiding surface, or flat chamfers are disposed to intersect with the second outer ring guiding surface at an obtuse angle.

12. The ball bearing according to claim 2, wherein pockets in which the respective balls are received are formed between respective circumferentially adjacent pairs of the pillars, and
wherein each of the pockets has an inner surface comprising a radially extending cylindrical surface.

13. The ball bearing according to claim 3, wherein pockets in which the respective balls are received are formed between respective circumferentially adjacent pairs of the pillars, and
wherein each of the pockets has an inner surface comprising a radially extending cylindrical surface.

14. The ball bearing according to claim 4, wherein pockets in which the respective balls are received are formed between respective circumferentially adjacent pairs of the pillars, and
wherein each of the pockets has an inner surface comprising a radially extending cylindrical surface.

15. The ball bearing according to claim 2, wherein pockets in which the respective balls are received are formed between respective circumferentially adjacent pairs of the pillars,
wherein each of the pockets has an inner surface comprising a spherical surface along a surface of a corresponding one of the balls,
wherein an opening of each of the pockets leading to an outer periphery of the crown-shaped resin cage has a circular arc edge that has a semicircular shape and that is axially open, and
wherein a distance between distal ends of corresponding ones of the outer ring guiding protrusions located on both circumferential sides of each of the balls so as to sandwich the ball is equal to or larger than a circular arc diameter of the circular arc edge of a corresponding one of the pockets.

16. The ball bearing according to claim 3, wherein pockets in which the respective balls are received are formed between respective circumferentially adjacent pairs of the pillars,
wherein each of the pockets has an inner surface comprising a spherical surface along a surface of a corresponding one of the balls,
wherein an opening of each of the pockets leading to an outer periphery of the crown-shaped resin cage has a circular arc edge that has a semicircular shape and that is axially open, and
wherein a distance between distal ends of corresponding ones of the outer ring guiding protrusions located on both circumferential sides of each of the balls so as to sandwich the ball is equal to or larger than a circular arc diameter of the circular arc edge of a corresponding one of the pockets.

17. The ball bearing according to claim 4, wherein pockets in which the respective balls are received are formed between respective circumferentially adjacent pairs of the pillars,
wherein each of the pockets has an inner surface comprising a spherical surface along a surface of a corresponding one of the balls,
wherein an opening of each of the pockets leading to an outer periphery of the crown-shaped resin cage has a circular arc edge that has a semicircular shape and that is axially open, and
wherein a distance between distal ends of corresponding ones of the outer ring guiding protrusions located on both circumferential sides of each of the balls so as to sandwich the ball is equal to or larger than a circular arc diameter of the circular arc edge of a corresponding one of the pockets.

18. The ball bearing according to claim 3, wherein a distance between distal ends of corresponding ones of the ball retaining claws of the pillars circumferentially opposed to each other so as to sandwich each of the balls is set to 80% or more and 92% or less of a diameter of the ball.

19. An eccentric rotation device comprising:
a rotary shaft configured to rotate at a predetermined position;
an eccentric shaft portion having a cylindrical outer periphery having a center axis at a position displaced from a rotation center axis of the rotary shaft, the eccentric shaft portion being configured to rotate eccentrically around the rotation center axis of the rotary shaft; and
the ball bearing according to claim 2 mounted to an outer periphery of the eccentric shaft portion.

20. An eccentric rotation device comprising:
a rotary shaft configured to rotate at a predetermined position;
an eccentric shaft portion having a cylindrical outer periphery having a center axis at a position displaced from a rotation center axis of the rotary shaft, the eccentric shaft portion being configured to rotate eccentrically around the rotation center axis of the rotary shaft; and
the ball bearing according to claim 3 mounted to an outer periphery of the eccentric shaft portion.
